(19) United States
(12) Patent Application Publication
(10) Pub. No.: US 2025/0144828 A1
(43) Pub. Date: May 8, 2025

(54) SCISSORS TOOL AND TOOL GROUP

(71) Applicant: WEZAG GmbH & Co. KG, Stadtallendorf (DE)

(72) Inventor: Roman Zinser, Neustadt (DE)

(21) Appl. No.: 18/935,170

(22) Filed: Nov. 1, 2024

(30) Foreign Application Priority Data
Nov. 3, 2023 (EP) 23 207 618.2

(51) Int. Cl. B26B 13/06

(52) U.S. Cl. CPC B26B 13/06

(57) ABSTRACT

A scissors tool for incising and cutting a cable, comprising a first scissors part and a second scissors part, which are mounted on each other via a scissors joint so that they can pivot about a scissors pivot axis. The first and second scissors parts each comprise a finger accommodation rendering it is possible to induce a pivoting movement of the scissors parts in a closing direction. Furthermore, the scissors parts each comprise a separating cutting blade. The separating cutting blades are moved towards each other with a pivoting movement of the scissors parts in the closing direction for cutting a cable. A stripping incision blade is movably guided on the first scissors part between an insertion position and an incision position. An actuating element is integrated into the finger accommodation of the first scissors part. A drive connection connects the actuating element to the stripping incision blade.

### CROSS REFERENCE TO RELATED APPLICATIONS

This application claims priority to co-pending European Patent Application No. 23 207 618.2, filed Nov. 3, 2023, the disclosure of which is hereby incorporated herein by reference in its entirety.

### FIELD OF THE INVENTION

The invention relates to a tool by which, on the one hand, a cable can be cut to a desired length and, on the other hand, a stripping incision cut can be made in an end region of an insulation sheath of the cable. Furthermore, the invention relates to a tool group with tools of different designs.

### BACKGROUND OF THE INVENTION

EP 3 054 542 B1 discloses stripping pliers comprising a fixed pliers part with a fixed hand lever and a fixed pliers jaw and a movable hand lever which is coupled to a movable pliers jaw via a toggle lever drive. The stripping pliers have separating cutting blades. One separating cutting blade is attached to the movable hand lever and is pivoted with it in the direction of the other separating cutting blade to generate a closing movement. The separating cutting blades can be used to cut the cable to the desired length. The stripping pliers also comprise stripping blades guided on the pliers jaws. The closing movement of the hand levers and therefore of the pliers jaws is divided into an incision stroke part and a stripping stroke part. During the incision stroke, the stripping blades incise on opposite sides into an insulation sheath of a cable inserted into the bit of the stripping pliers. The stripping blades are mounted on a carriage that can be displaced in the longitudinal direction of the cable inserted into the bit of the stripping pliers. In the stripping stroke part, the stripping blades are moved in the longitudinal direction of the cable as a result of the movement of the carriage caused by the hand levers in such a way that the previously at least partially incised end section of the insulation sheath is stripped from the cable by means of the stripping blade.

US 6 526 661 B1 discloses a scissors tool with a first scissors part and a second scissors part which are mounted to each other via a scissors joint for being pivotable about a scissors pivot axis. In the end region facing away from the scissors joint, the scissors parts each comprise a finger accommodation, by which it is possible to induce the pivoting of the scissors parts in a closing direction. The scissors tool has three workpiece processing regions, wherein a workpiece can be incised or cut by closing the scissors parts. In the first workpiece processing region, which is located closest to the scissors joint, the two scissors parts each have a pair of cutting blades, by means of which the insulating sheath of a ribbon cable is to be incised when the scissors parts are closed and the insulation thus incised is to be stripped off the ribbon cable by means of a subsequent axial movement. In a second, centrally arranged workpiece processing region one scissors part forms an edge-closed accommodation for a cable with a circular cross-section. The other scissors part carries an incision cutting blade in the second workpiece processing region, which incises the insulation of the cable arranged in the accommodation during the closing movement of the scissors parts. By twisting the scissors tool around the cable, the insulation can be incised in the circumferential direction, and with the subsequent axial movement the end section of the insulation that was separated by the circumferential incision can be stripped off. Finally, in the outer third workpiece processing region the scissors tool has an open cutting recess in one scissors part, into which a cable can be inserted, as well as a cutting blade carried by the other scissors part. When the scissors parts close, the cable placed in the cutting recess can be incised or cut by means of the cutting blade. The incision cutting blade of the second workpiece processing region and a cutting blade of the third workpiece machining area are part of a common blade body. The blade body is mounted on the associated scissors part for being pivoted about a pivot axis. The back of the cutting body is supported for being pivoted by a knurled screw at location remote from the pivot bearing. The cutting depth of the incision blade in the second workpiece processing region and of the cutting blade in the third workpiece machining area can be adjusted by adjusting the knurled screw.

Further prior art is known from US 6 138 362 A, US 2019/210206 A1 and GB 2 181 687 A corresponding to US 4 658 456 A.

### SUMMARY OF THE INVENTION

To start with, it is proposed that the tool for cutting through and for the provision of a stripping incision is embodied as a scissors tool rather than a pliers tool. The scissors tool comprises a first scissors part and a second scissors part. The two scissors parts are mounted to each other via a scissors joint so that the scissors parts can be pivoted relative to each other about a scissors pivot axis which is defined by the scissors joint.

The two scissors parts each comprise a finger accommodation by which the scissors parts can be manually pivoted in a closing direction by inserting at least one finger of a user (in particular a thumb and an index or middle finger) into a finger accommodation, the fingers then being able to apply the finger closing forces on the scissors parts. The finger accommodation can be open-edged. Preferably, however, the finger accommodations have closed edges (for example the finger accommodations circular through recesses, elliptical through recesses or have any other shape of closed-edged recesses of the scissors parts).

The scissors parts each comprise a separating cutting blade. The separating cutting blades are moved towards each other as the scissors parts are pivoted in a closing direction, which is brought about by the finger closing forces applied by the user in the finger accommodation. If there is a cable between the separating cutting blades, the cable can be cut through in this way. The scissors tool thus provides the first desired function of providing that a cable is cut through.

Furthermore, it is proposed that an actuating element is integrated into the finger accommodation of the first scissors part. In addition to the separating cutting blades, the scissors also comprise a stripping incision blade. The stripping incision blade is movably guided on the first scissors part. In one embodiment the actuating element arranged in the finger accommodation is connected to the stripping incision blade via a drive connection. When the user actuates the actuating element, the stripping incision blade can thus be moved to a desired position. In the present context, the finger accommodation of the first scissors part can thus be used multifunctionally, since on the one hand the closing movement of the separating cutting blades for cutting through the cable can be brought about via this finger accommodation and on the other hand a movement of the stripping incision blade into a desired position can be brought about via the actuating element arranged in the finger accommodation.

A tool as describe above and/or in the following can in particular be used for providing
a) a cutting through a cable (separating cut)
b) as well as a stripping incision cut in an end section of an insulation sheath of the cable.

A tool like this can e.g. be improved with regard to
the manufacturing costs and/or
the materials that can be used and/or
the applicable manufacturing process for the components and/or
the factory assembly and/or
the number of components required and/or
the constructional size and/or
the comfort of use and/or
the constructional size and visual design.

Any design of the drive connection can be used, in particular a geared connection, a lever connection or any other connection, possibly also with a gearing up or gearing down of the forces and movement. Preferably, a rigid connection is used as the drive connection, so that the actuating element on the one hand and the stripping incision blade are firmly connected to each other.

Preferably, the finger accommodation of the first scissors part comprises two circumferential regions that are separate from each other and offset in the circumferential direction. If the user's two fingers are inserted into the two finger accommodations of the scissors parts and the scissors parts are actuated to bring about the closing movement of the separating cutting blades, one finger biases a first circumferential region of the finger accommodation of the first scissors part. The finger closing forces generated therewith are then oriented in the circumferential direction around the scissors joint, so that the first circumferential region comprises a surface normal that is oriented approximately in the circumferential direction around the scissors joint. In order to avoid unintentional actuation of the actuating element during this manually induced movement of the separating cutting blades, the actuating element is arranged outside this first circumferential region, namely in a second circumferential region. The second circumferential region, in which the actuating element is arranged, can then be arranged in any other circumferential region. For example, it is possible that this second circumferential region is arranged on the side opposite to the first circumferential region or that the surface normal of the second circumferential region is oriented approximately towards the scissors joint, wherein deviation angles of +/−30°, +/−20° or +/−15° of the surface normal of the second circumferential region relative to the direction towards the scissors joint are also possible.

In one embodiment, the scissors tool comprises a spring device which biases the stripping incision blade into an initial position. In this case, the initial position can be an insertion position so that, in order to generate cutting forces, the user must apply forces to the actuating element that are oriented opposite to the action of the spring device. Accordingly, the actuation of the actuating element increases the force biasing the spring device. Preferably, however, the stripping incision blade is biased by the spring device towards an incision position. The spring device thus automatically generates the force by which the stripping incision blade is pressed onto the insulation sheath of the cable and by which the insulation sheath is incised. The force characteristics for pressing the stripping incision blade against the insulation sheath can be designed by the choice of the spring device's spring stiffness and length. However, in order to enable the cable to be inserted into the working area of the stripping incision blade, the stripping incision blade must then be moved from the incision position to an insertion position while increasing the force biasing the spring device. This can be accomplished by the user by actuating the actuating element.

Another way of influencing the contact pressure characteristic of the stripping incision blade on the insulation sheath is that the spring device can be pretensioned. In this way, a basic level of spring force of the spring device in the insertion position can be set which depends on the extent of the pretension and, on the other hand, the increase in spring force from this base level as a function of the movement of the stripping incision blade from the insertion position to the incision position can be set by selecting the spring stiffness. This makes it e. g. also possible to provide an adaptation to different diameters or insulation layer thicknesses of the cable to be stripped and/or different materials of the insulation jacket, which require different contact pressures of the stripping incision blade.

In the present context, “cutting in” or “incision” is understood to mean cutting in at least a partial circumference of the insulation sheath of the cable, without the process carried out with the scissors tool necessarily comprising a stripping stroke in which the end piece incised by the stripping incision blade is automatically stripped.

In one embodiment of the scissors tool, the actuating element protrudes into the finger accommodation of the first scissors part. Preferably, the maximum movement of the actuating element (and thus of the stripping incision blade), which can be brought about by means of the finger in the finger accommodation, is limited to the insertion position into which the actuating element can be moved. In this insertion position, the actuating element and a limitation of the finger accommodation of the first scissors part are arranged flush with each other. In other words, the extent to which the actuating element projects into the finger accommodation of the first scissors part thus defines the maximum stroke of the actuating element to the insertion position.

Any materials and/or manufacturing processes can be used for the design of the aforementioned components. The spring device can, for example, be embodied as one or more metallic springs of any design (in particular a leaf spring, a torsion or leg spring, a spiral spring embodied as a tension spring or compression spring, etc.). For a particular proposal, the actuating element, a stripping incision blade holder and the spring device are manufactured in one single piece. In this case, the spring device is embodied as an elastic material section. For example, the actuating element, the stripping incision blade holder and the spring device can be manufactured in one single piece from plastic, wherein manufacture can take place using an injection molding process or an additive process, in particular 3D printing. To give just one example, the actuating element and a stripping incision blade holder can be formed by a block-like or plate-like incision base body, from which at least one integral spring arm of any shape then extends, which then forms the spring device. In this case, the spring stiffness of the spring device results from the modulus of elasticity of the material used and the geometry and cross-section of the spring arm, in particular the length of the spring arm and the geometrical moment of inertia of the spring arm.

For a further proposal, (in contrast to classic scissors) the first scissors part forms a housing with an inner chamber. The inner chamber can then be used to support, guide and/or arrange at least one (in particular moving) component of the scissors tool. For example, a subsection of the actuating element, the stripping incision blade holder, the spring device and/or a subsection of the stripping incision blade can be supported, guided and/or arranged in the inner chamber. The scissors joint or a scissors joint pin can also extend through the inner chamber. Furthermore, the separating cutting blades can be arranged at least partially in the region of the inner chamber, wherein these can then also move out of the inner chamber during the closing stroke. Preferably, the housing comprises two housing parts having, for example, a central or eccentric dividing plane. It is possible that the housing comprises a housing base body that is closed by a housing cover or lid.

The following alternative or cumulative further design options are available for the aforementioned designs:
It is possible that the two housing parts, in particular the housing cover and the housing base body, are connected to each other (also or exclusively) by means of a latching connection, a locking mechanism or a clipping mechanism. To give just one example, a latching projection of one housing part can be latched to a latching recess of the other housing part. The latching effect can be designed by the choice of the elasticity of the support of the latching protrusion and/or of the latching recess as well as an angle of inclination and the design of the contact surfaces between the latching protrusion and the latching recess.
In the simplest case, at least one housing part comprises latching hooks that are latched with corresponding latching recesses in the other housing part.
The aforementioned connections can be the only connections between the two housing parts. It is also possible for the housing parts to be additionally screwed, glued or welded together.
It is also possible that a seal is arranged between the housing parts.
The housing parts (in particular the housing cover or lid and/or the housing base body) can comprise a protrusion, a rib, a recess or a groove. The protrusion, the rib, the recess or the groove can ensure guidance of a component (for example, the actuating element and/or the stripping incision blade holder) that moves during the stroke of the actuating element and/or during the stroke of the separating cutting blades. It is also possible that the protrusion, the rib, the recess or the groove provides a stop for a movement of a component (in particular of the actuating element and/or of the stripping incision blade holder). To give just one further example, the protrusion, the rib, the recess or the groove can serve to support a spring base of the spring device.
It is also possible that a protrusion, a rib, a recess or a groove is used for the accommodation or support of a fixed separating cutting blade and/or for a securing of a stripping incision blade against emerging from a recess of a stripping incision blade holder in a direction opposite to the mounting direction.
The protrusion, rib, recess or groove can alternatively or cumulatively also provide a cable contact surface which supports a cable to be incised and then stripped off on the side facing away from the stripping incision blade, wherein the cable contact surface can also carry a supporting rib or lib or engagement rib or lip or a stripping incision blade.
It is possible that the housing cover and/or the housing body are made of plastic.

In a particular embodiment, the first scissors part (here, for example, a housing part) and/or the second scissors part comprise an accommodation. The associated separating cutting blade can be arranged and supported in the accommodation. This will be explained with reference to the following non-limiting example: It is possible that the accommodation is embodied as a recess, the depth and contour of which corresponds to the thickness and shape of the separating cutting blade. If the separating cutting blade is then inserted into this accommodation, the separating cutting blade is positively received and supported in the plane transverse to the insertion direction. Preferably, the separating cutting blade is inserted into the accommodation in an insertion direction that is parallel to the scissors pivot axis. After insertion, the separating cutting blade can be arranged flush with an upper side of the scissors part or can be set back inwards relative to it or protrude outwards.

For a further proposal, a screw (exclusively one screw or at least one screw) is present in the scissors tool. The screw defines the scissors pivot axis. In this case, the shaft of the screw can form the scissor joint pin. Alternatively or cumulatively, depending on the tightening torque of the screw, the pressing of the scissors parts against each other can be specified by means of the screw. In this way, the screw defines the friction that counteracts any pivoting of the scissors parts around the scissors joint, so that the screw can be used to set the required operating forces and the frictional force that secures the position of the scissors parts. Alternatively or cumulatively, the screw can be used to set the separating cutting blade clearance. The screw can thus be used multifunctionally. It is also possible that, in addition to at least one of the functions mentioned, the screw also ensures that housing parts or components of an assembly subunit are secured to each other.

A further proposal aims for simplifying the assembly of the scissors tool. In this respect, it is proposed that (preferably all) components of the scissors tool are joined in the same assembly direction, this assembly direction being oriented parallel to the scissors pivot axis. This design enables automated assembly by means of a robot, which only needs to join the parts in a single assembly direction for assembly. Handling and twisting of components or of an assembly subunit during assembly is therefore unnecessary in this case.

It is possible that in the scissors tool, the cutting edge of the stripping incision blade on the one hand and a cable contact surface on the other hand, between which the cable is clamped, are oriented parallel to each other. The cable contact surface is fixedly arranged on the first pliers part, the cable contact surface preferably comprising a cutting edge or a supporting lip or rib. For a particular proposal, the cutting edge of the stripping incision blade is inclined at an acute angle relative to the cable contact surface, wherein this acute angle can be, for example, 1° to 20°, 2° to 15° or 3° to 10°. Such an inclination of the cutting edge of the stripping incision blade relative to the cable contact surface has proven to be particularly advantageous if the cable is rotated for incising the insulation sheath over the entire circumference, so that the cutting edge can cut the entire circumference of the insulation sheath. Depending on the direction of rotation of the cable relative to the cutting edge and thus the scissors tool, there may even be different incision depths of the cutting edge of the stripping incision blade into the insulation sheath of the cable.

It is possible that components of the scissors tool are made of plastic, which may also be a biogenic plastic, i.e. a biodegradable plastic. The components that can be made of plastic can be, for example, the housing parts, the actuating element, the stripping incision blade holder and the spring device as well as an incision base body of the second scissors part. Preferably, all components (except the at least one stripping incision blade, the separating cutting blades and the screw) are made of plastic, while the stripping incision blade, the separating cutting blades and the screw can then be made of metal.

Another proposal is directed to a tool group. The tool group comprises at least one scissors tool and at least one pliers tool. The scissors tool on the one hand and the pliers tool on the other hand are used for different applications. Such a tool group can, for example, be produced and offered by one manufacturer. In this case, customers can only purchase scissors tools, only purchase pliers tools or purchase both tools from this manufacturer. It is also possible for such a tool group to be kept in stock and offered by a commercial intermediary. It is also possible that such a tool group is kept in stock and used by the consumer.

In the tool group, the scissors tools are designed as explained above. The scissors tool and the pliers tool of the tool group comprise identical separating cutting blades. In this case, the separating cutting blades of the scissors tool are actuated via a pivoting of the scissors parts of the scissors tool, while the separating cutting blades of the pliers tool are actuated via a pivoting of the pliers hand lever of the pliers tool. For example, the pliers tool can be embodied as described at the beginning of publication EP 3 054 542 B1 and explained in detail in this publication. By equipping the scissors tool on the one hand and the pliers tool on the other hand with identical separating cutting blades, the manufacturing costs can be reduced as a result of the increase in the number of identical parts. As the separating cutting blades may be wearing parts, the customer's stock of separating cutting blades for the scissors tool and the pliers tool for a replacement is reduced, as one and the same separating cutting blade can be kept in stock for the two different tools. The pliers tool can provide an extended range of functions compared to the scissors tool. In the case of a pliers tool according to EP 3 054 542 B1, the pliers tool provides, on the one hand, the cutting of a cable by means of a separating cutting blade and, on the other hand, the creation of an incision stroke part and a stripping stroke part by use of the stripping incision blades.

Advantageous developments of the invention result from the claims, the description and the drawings.

The advantages of features and of combinations of a plurality of features mentioned at the beginning of the description only serve as examples and may be used alternatively or cumulatively without the necessity of embodiments according to the invention having to obtain these advantages.

The following applies with respect to the disclosure—not the scope of protection—of the original application and the patent: Further features may be taken from the drawings, in particular from the illustrated designs and the dimensions of a plurality of components with respect to one another as well as from their relative arrangement and their operative connection. The combination of features of different embodiments of the invention or of features of different claims independent of the chosen references of the claims is also possible, and it is motivated herewith. This also relates to features which are illustrated in separate drawings, or which are mentioned when describing them. These features may also be combined with features of different claims. Furthermore, it is possible that further embodiments of the invention do not have the features mentioned in the claims which, however, does not apply to the independent claims of the granted patent.

The number of the features mentioned in the claims and in the description is to be understood to cover this exact number and a greater number than the mentioned number without having to explicitly use the adverb “at least”. For example, if an element is mentioned, this is to be understood such that there is exactly one element or there are two elements or more elements. Additional features may be added to these features, or these features may be the only features of the respective product.

The reference signs contained in the claims are not limiting the extent of the matter protected by the claims. Their sole function is to make the claims easier to understand.

### BRIEF DESCRIPTION OF THE DRAWINGS

In the following, the invention is further explained and described with reference to preferred embodiments shown in the figures.

FIG. 1 shows a scissors tool in a rear view, with the scissors parts and separating cutting blades being in an insertion position and an actuating element and a stripping incision blade being in an insertion position as a result of a manual actuation.

FIG. 2 shows a front view of the scissors tool as shown in FIG. 1 with the housing cover removed.

FIG. 3 shows the scissors tool according to FIGS. 1 and 2 in a rear view, with the scissors parts and the separating cutting blades in a separating position and the actuating element and the stripping incision blade in an incision position.

FIG. 4 shows a front view of the scissors tool as shown in FIG. 3 with the housing cover removed.

FIGS. 5 and 6 show exploded views of the scissors tool according to FIGS. 1 to 4.

FIG. 7 shows an individual part drawing of a housing cover from the inside.

FIG. 8 shows a sectional view of the scissors tool according to FIGS. 1 to 6 with a section through the housing cover.

FIG. 9 shows a sectional view of the scissors tool according to FIGS. 1 to 6 with a section through an incision body of the second scissors part and the actuating element, the stripping incision blade holder and the spring device.

FIG. 10 shows a three-dimensional representation of the housing base body with ribs, recesses and latching hooks formed thereon.

FIG. 11 shows a front view of a pliers tool.

FIG. 12 shows the pliers tool according to FIG. 11 in an exploded view.

### DETAILED DESCRIPTION

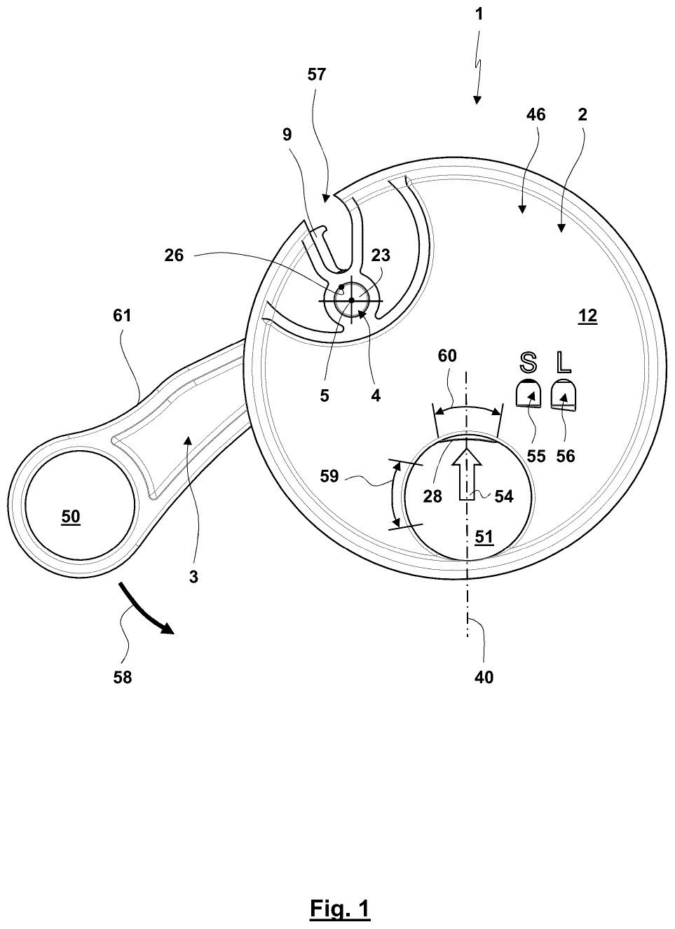

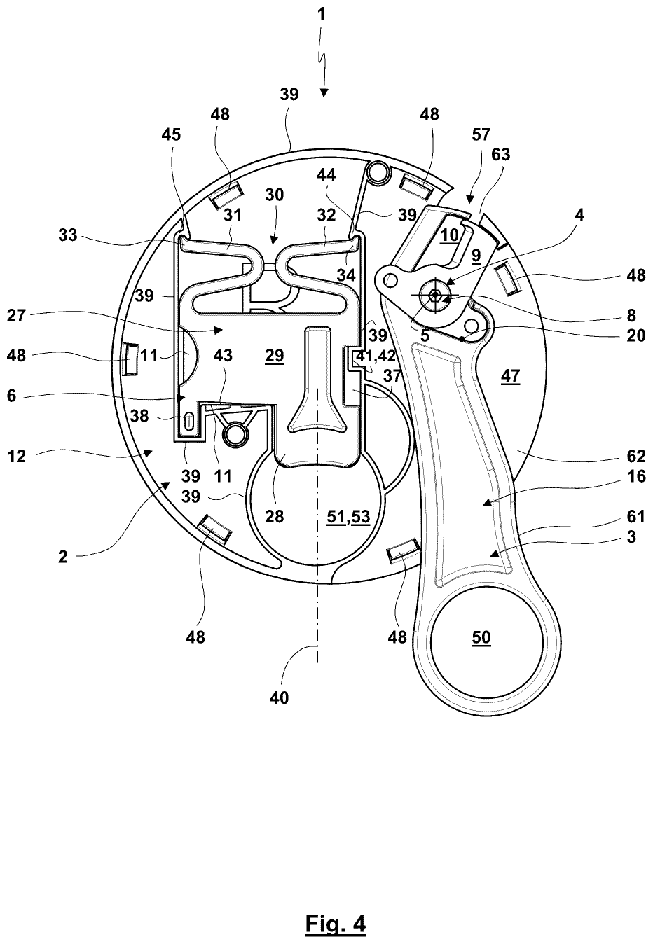

The figures show a scissors tool 1. The scissors tool 1 comprises three components or assemblies that can be moved relative to one another in operation, namely
a first scissors part 2, a second scissors part 3, which are mounted to each other by a pivot bearing 4 for being pivoted about a scissors pivot axis oriented vertically to the drawing plane according to FIGS. 1 to 4 and for being pivoted relative to one another in a separating stroke, and
an incision unit 6, which is movable in an incision stroke relative to the first scissors part 2.

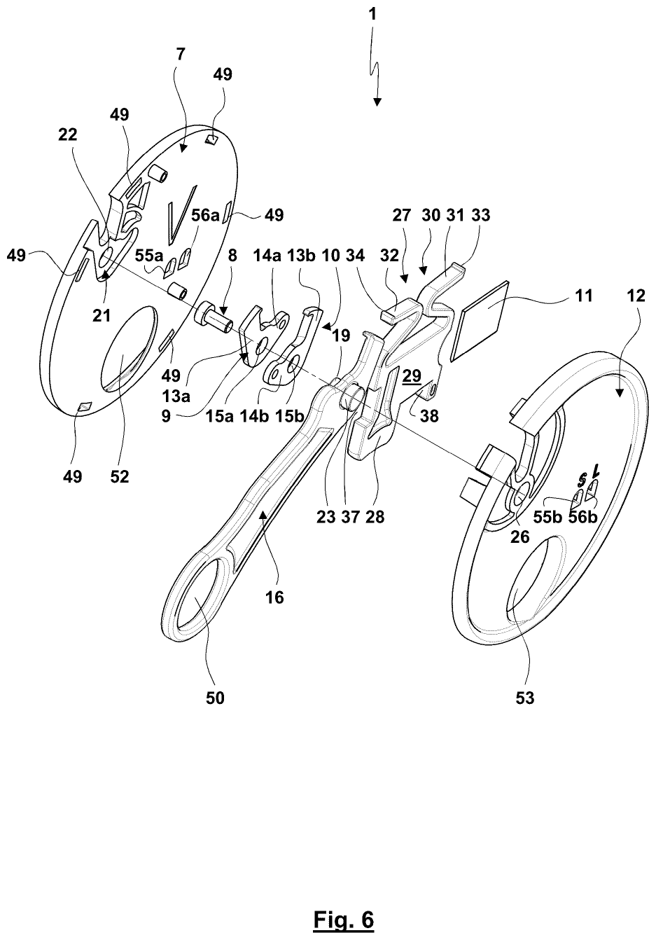

In the exploded view shown in FIG. 6, it can be seen that the scissors tool 1 comprises only the following components:
a housing cover or lid 7,
a screw 8,
two separating cutting blades 9, 10,
the incision unit 6, which is embodied as a single piece here,
a stripping incision blade 11 and
a housing base body 12.

The separating cutting blades 9, 10 are L-shaped with two angled legs 13, 14. In the figures the legs 13, 14 of the separating cutting blade 9 are marked with the suffix “a”, while the legs 13, 14 of the separating cutting blade 10 are marked with the suffix “b” (see FIG. 6). In the transition area of the legs 13, 14 there is a bore 15, which is also marked with the suffix “a” respectively “b”.

The first scissors part 2 comprises a lever-like base body 16 comprising lever parts 17, 18. A cylindrical protrusion 19 is arranged in the transition area of the lever parts 17, 18. The diameter of the protrusion 19 corresponds (with a fit or clearance) to the diameter of the bores 15 of the separating cutting blades 9, 10, so that the separating cutting blades 9, 10 can be placed on the protrusion 19.

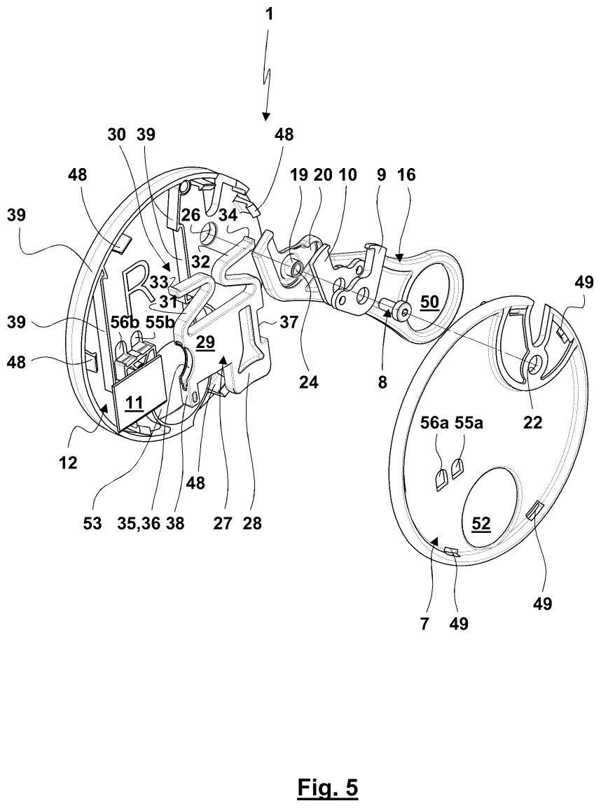

The protrusion 19 is surrounded by an accommodation 20 (see FIG. 5). The depth of the accommodation 20 preferably corresponds to the thickness of the separating cutting blade 10. Furthermore, the outer contour of the accommodation 20 corresponds to the outer contour of the separating cutting blade 10. Thus, with the placement of the separating cutting blade 10 on the protrusion 19, the separating cutting blade 10 can be inserted into the accommodation 20, whereby it is received in the accommodation 20 with a positive form fit. The lever part 17 supports the leg 13a forming the cutting edge of the separating cutting blade 10 both in the circumferential direction around the scissors pivot axis 5 as well as in the supporting direction on the base of the accommodation 20.

When the separating cutting blades 9, 10 are placed on the protrusion 19, they are held on the base body 16 via the screw 8. The separating cutting blades 9, 10 are trapped between the head of the screw 8 and the base body 16. A shank of the screw 8 extends through the bores 15a, 15b of the separating cutting blades 9, 10. In the end region facing away from the head of the screw 8 which protrudes from the separating cutting blades 9, 10, the thread of the screw 8 is screwed to a bore 24 of the protrusion 19. If the protrusion 19 is made of plastic, the screw 8 can be screwed into the cylindrical bore 24 of the protrusion 19 in a self-cutting manner. The tightening torque of the screw 8 specifies the cutting edge clearance of the separating cutting blades 9, 10 and also determines the friction between the separating cutting blades 9, 10 during the movement of the scissors parts 2, 3. When the screw 8 is screwed in, the base body 16 forms an assembly unit with the separating cutting blades 9, 10. This assembly unit is pivotably connected to the housing cover 7 which is due to the fact that the head of the screw 8 finds fitting accommodation in a bore 22 of the housing cover 7.

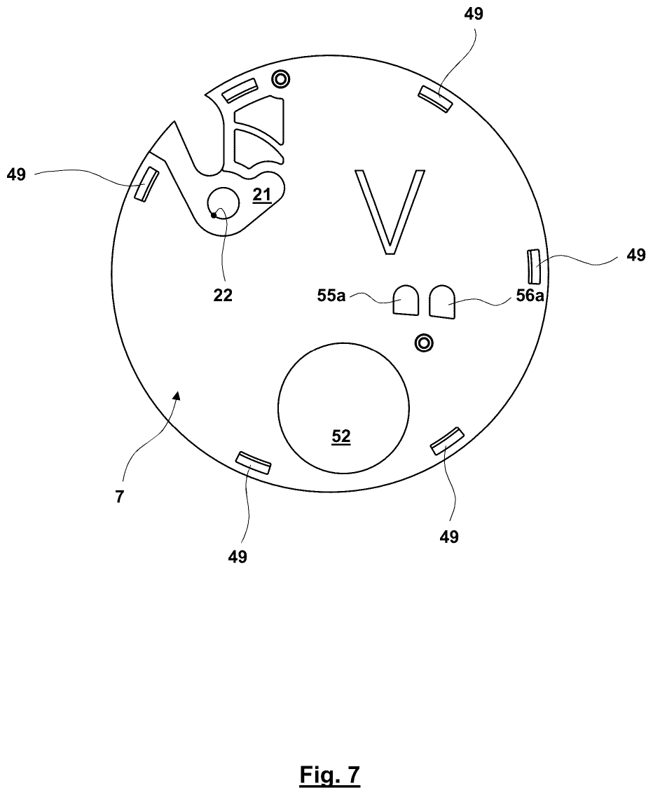

As can be seen in FIGS. 6 and 7, the housing cover 7 comprises an accommodation 21. The depth of the accommodation 21 corresponds to the thickness of the separating cutting blade 9 and the outer contour of the accommodation 21 is adapted to the outer contour of the separating cutting blade 9. With the insertion the separating cutting blade 10 is accommodated with a positive form fit in the accommodation 21. As a result of the positive fit of the separating cutting blade 10 in the accommodation 20 of the base body 16 and of the separating cutting blade 9 in the accommodation 21 of the housing cover 7, a relative pivoting of the first scissors part 2 and the second scissors part 3 leads to a relative pivoting of the separating cutting blades 9, 10, whereby the separating cutting blades 9, 10 can be transferred from an insertion position to a separating position (and vice versa).

The base body 16 also comprises a protrusion 23 on the side facing towards the housing base body 12, which is accommodated (with a clearance or a fit) in a bore 26 of the housing base body 12.

The incision unit 6 comprises an incision base body 27 made in one single piece from plastic. The incision base body 27 comprises a tongue-like actuating element 28, a stripping incision blade holder 29 and a spring device 30, which here comprises two spring arms 31, 32. The spring arms 31, 32 are each swan-neck-shaped or V-, U- or Z-shaped and allow a deflection as a result of their inherent elasticity, the spring arms 31, 32 being subjected to bending. The spring arms 31, 32 each comprise a protrusion 33, 34 or hook-shaped end region in the end region facing away from the stripping incision blade holder 29.

The stripping incision blade holder 29 comprises an inner chamber 35 into which the stripping incision blade 11 can be inserted via a lateral assembly opening 36. On the side opposite the assembly opening 36, the stripping incision blade holder 29 forms a stopping recess 37. Furthermore, a protrusion 38 extends from the stripping incision blade holder 29 parallel to an actuating axis 40 of the actuating element 28.

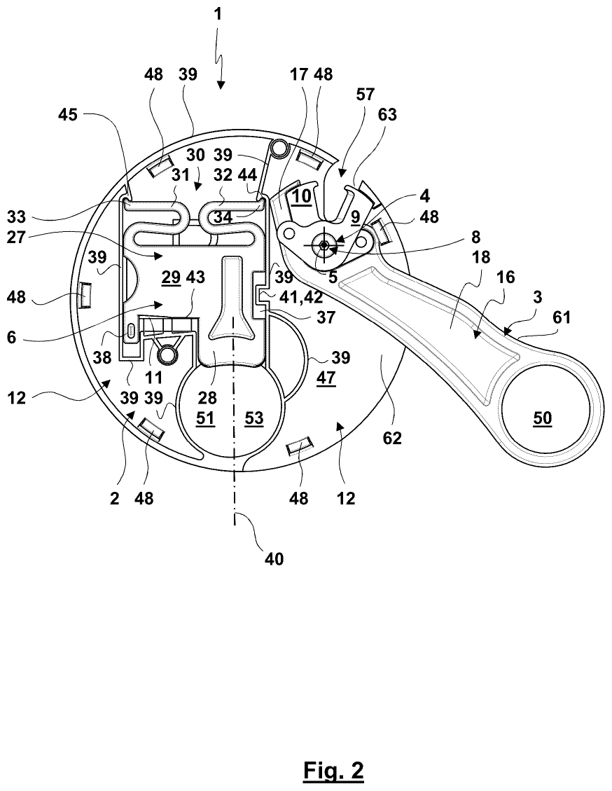

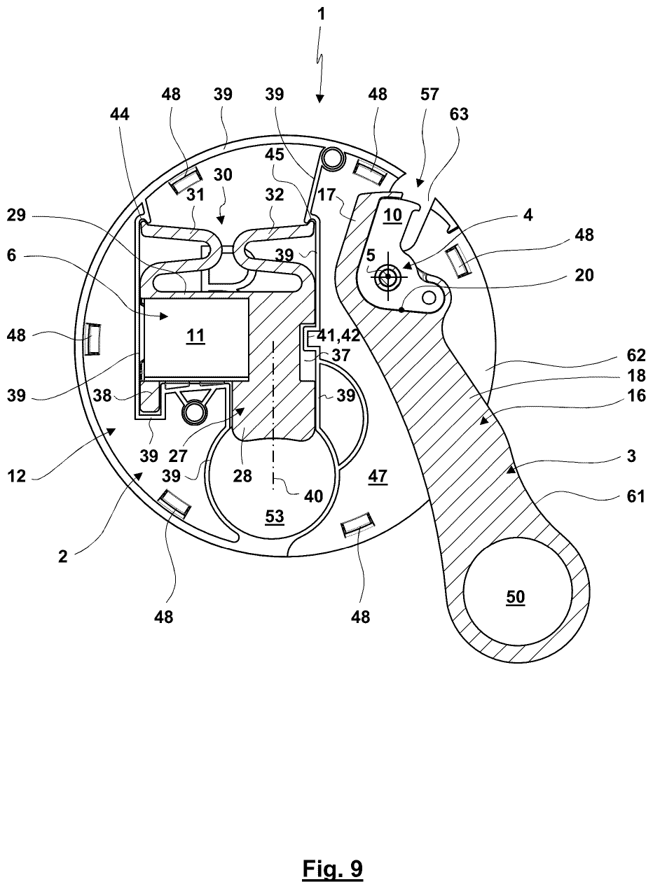

As can be seen in particular in FIGS. 2, 4, 5 and 9, the housing base body 12 comprises ribs 39, the height of which approximately corresponding to the thickness of the incision base body 27. The ribs 39 are oriented parallel to the actuating axis 40 of the actuating element 28. The side surfaces of the incision base body 27 are guided in a sliding manner on the ribs 39, so that the incision base body 27 and thus the actuating element 28 and the stripping incision blade 11 can move only along the actuating axis 40. Furthermore, the ribs 39 form an accommodation in which the protrusion 38 of the incision base body 27 is guided. It is possible that the end face of the protrusion 38 is pressed against a stop formed by the rib 39 as a result of a preload of the spring device 30. In this way, the end position of the movement of the stripping incision blade 11 and the actuating element 28 is defined. Furthermore, the rib 39 can form a protrusion 41, which builds a stop 42 which comes to rest on the limitation of the stopping recess 37 in order to limit the stroke of the incision base body 27.

Furthermore, a rib 39 or a protrusion forms a cable contact surface 43, on which the cable can be placed in the insertion position of the incision unit 6. The cable is clamped between the cable contact surface 43 and the cutting edge of the stripping incision blade 41 as a result of the spring force of the spring device 30.

The ribs 39 can form accommodating recesses 44, 45 in which the protrusions 33, 34 of the spring arms 31, 32 are accommodated for securing the spring bases of the spring arms 31, 32 to the housing base body 12.

The scissors tool 1 is assembled as follows:

First, the separating cutting blade 10 is placed on the protrusion 19 of the base body 16 and inserted into the accommodation 20 of the base body 16.

The separating cutting blade 9 is then placed on the protrusion 19 of the base body 16.

Finally, the screw 8 is passed through the bores 15a, 15b and screwed to the bore 24 of the protrusion 19.

The assembly unit formed in this way is then inserted with the protrusion 23 into the bore 26 of the housing base body 12.

In parallel, a further assembly subunit can be provided by inserting the stripping incision blade 11 into the inner chamber 35 of the stripping incision blade holder 19 via the assembly opening 36.

This assembly subunit can then be inserted into the housing base body 12 by supporting the free spring bases of the spring arms 31, 32 on the ribs 39, which is done here by inserting the protrusions 33, 34 into the accommodating recesses 44, 45. At the same time, the section of the stripping incision blade holder 29 is inserted between the parallel guiding ribs 39, whereby the stop 42 simultaneously enters the stopping recess 37 and the protrusion 38 finds guiding accommodation between parallel sections of the ribs. The actuating element 28 is also accommodated between two parallel sections of the ribs 39. If the stripping incision blade holder 29 is inserted between the ribs 39 in this way, the stripping incision blade 11 cannot emerge from the assembly opening 36, as the assembly opening 36 is closed in the disassembly direction by the rib 39.

In the next step, the housing cover 7 can be placed on the housing base body 12, so that a closed housing 46 is provided. In the inner chamber 47 of the closed housing 46 the base body 16 with the separating cutting blades 9, 10 and the incision base body 27 with the spring device 30, the stripping incision blade holder 29 and the actuating element 28 as well as the stripping incision blade 11 are arranged. A connection between the housing cover 7 and the housing base body 12 is provided by elastic latching hooks 48 of the housing base body 12, which are distributed over the circumference and are latched in latching recesses 49 of the housing cover 7. Preferably, two latching hooks 48 and latching recesses 49 are arranged directly adjacent to a bit of separating cutting blades 57 established by the separating cutting blades 9, 10, into which the cable can be inserted for a separation cut.

The mounting direction for the aforementioned mounting steps is always or generally parallel to the scissors pivot axis 5. The stripping incision blade 11 is inserted into the stripping incision blade holder 29 vertically to the actuating axis 40.

The lever part 18 of the base body 16 forms a finger accommodation 50 in the outer end region, which is embodied as a circular bore here. The housing 46 also forms a finger accommodation 51. For this purpose, the housing cover 7 and the housing base 12 have aligned through bores 52, 53.

In an insertion position of the stripping incision blade 11 of FIG. 1, in which the end face of the actuating element 28 in the finger accommodation 51 is biased by a finger force 54, the actuating element 28 and thus also the stripping incision blade holder 29 with the stripping incision blade 11 is pressed into the inner chamber 47 of the housing 46 against the spring device 30, the end face preferably being flush with the finger accommodation 51.

The housing cover 7 and the housing base body 12 have aligned insertion openings 55a, 55b, 56a, 56b. For the embodiment shown there are pairs of aligned insertion openings 55a, 55b and 56a, 56b in each case.

In the insertion position, the intermediate space between the cable contact surface 43 and the cutting edge of the stripping incision blade 11 is accessible via the insertion openings 55, 56, so that it is possible to insert a cable which, depending on the length of the end section of the insulation sheath to be removed, can also protrude from the housing 46 with a free end section. If the cable contact surface 43 and the cutting edge of the stripping incision blade 11 are inclined at an acute angle relative to each other, the pairs of insertion openings 55a, 55b and 56a, 56b can be used to produce incisions in cables with different diameters or different hardnesses of the insulation sheath.

The scissors tool 1 can be used as follows:

If the scissors parts 2, 3 are in the open position as shown in FIG. 1, a cable can be inserted into the bit of separating cutting blades 57 formed between the separating cutting blades 9, 10. If the second scissors part 3 is pivoted in a closing direction 58, the separating cutting blades 9, 10 are moved towards each other and closed, thereby cutting through the cable. During the generation of the closing movement, two fingers (in particular a thumb and an index finger or a middle finger) are located in the finger accommodations 50, 51. The finger arranged in the finger accommodation 51 then generates a closing force in a first circumferential region 59 of the finger accommodation 51, the surface normal of which is oriented approximately vertically to the axis of connection to the pivot axis 5 or in the circumferential direction of the pivot axis 5.

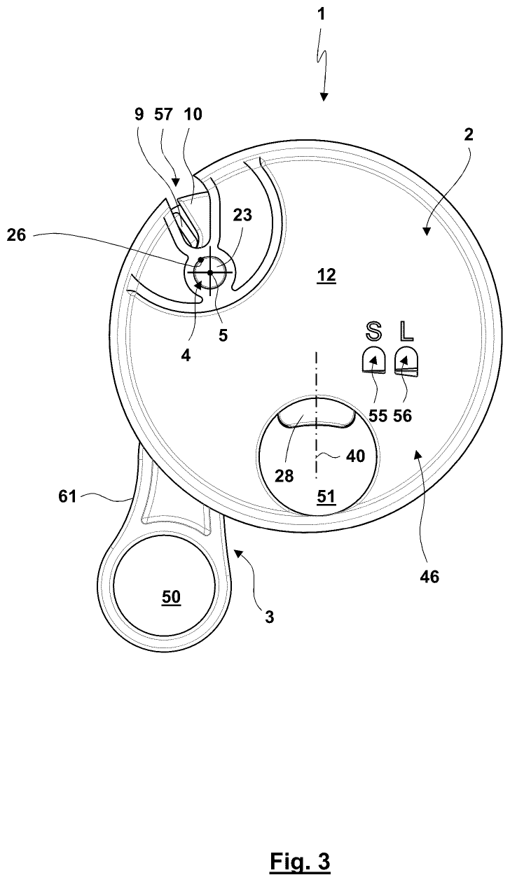

If, on the other hand, the cable is to be incised by creating the incisions in the insulation sheath, the user inserts a finger (in particular the thumb) into the finger accommodation 51 while the rest of the hand grips the housing 46. The finger located in the finger holder 51 can then be used to apply the finger force 54 to the actuating element 28, whereby the stripping incision blade holder 29 and the stripping incision blade 11 arranged therein are transferred from the incision position according to FIG. 3 to the insertion position according to FIG. 1. It is then possible to insert the end section of the cable into the respective insertion opening 55, 56. If the finger force 54 is then removed, the spring device 30 presses the stripping incision blade holder 29 with the stripping incision blade 11 against the outer surface of the cable, which is supported on the opposite side on the cable contact surface 43, thereby causing that a partial circumferential incision is provided in the insulation sheath. If not only a partial circumferential area of the insulation sheath is to be incised, the user can also generate a relative rotational movement between the cable and the housing 46, whereby the cutting edge of the stripping incision blade 11 is moved along the circumference of the insulation sheath. It is also possible that a rotation of more than 360° takes place if the cutting depth of the stripping incision blade 11 is to be successively increased. Without this necessarily being the case, the scissors tool 1 can also be moved relative to the cable in the direction of the longitudinal axis of the cable at the end of the incision process, allowing the previously incised end section of the insulation sheath to be stripped by the stripping incision blade 11. If the insulation sheath has not previously been incised along the entire circumference, the end section can be torn off in the remaining circumferential area.

In the finger accommodation 51, the end face of the actuating element 28 to be actuated is arranged in a second circumferential region 60. The first circumferential region 59 and the second circumferential region 60 are arranged offset to one another. It is possible, for example, that the surface normal of the second circumferential region 60 is oriented in the direction of the connection axis with the scissors pivot axis 5 or inclined at an angle of +/−30° thereto.

It is possible that the separating cutting blades 9, 10 lie against each other with their cutting edges in the separating position (or form a minimal gap). However, it is also possible that the separating cutting blades 9, 10 overlap in an end position, so that the cutting edges of the separating cutting blades 9, 10 pass each other during the closing movement and a so-called bypass cut is produced. Preferably, the separating cutting blades 9, 10 are embodied as identical parts.

It is also possible that the cable contact surface 43 also comprises a stripping incision blade or a plastic lip or rib. A plastic lip or rib can be used to provide additional guidance when rotating the cable relative to the scissors tool 1 by allowing this plastic lip or rib to enter into a previously incised area of the insulation sheath.

It is possible that the base body 16 comprising a finger cavity 61 adjacent to the finger accommodation 50, on which another finger of the user can be supported. It is possible, for example, that for actuating the separating cutting blades 9, 10 the thumb is arranged in the finger accommodation 50, the index finger is supported on the finger cavity 61 and the middle finger is arranged in the finger accommodation 51.

It is possible that the cover is also closed in the area of the bore 22. It is also possible that the screw 8 is screwed through the bore 22 of the housing cover 7 when the housing cover 46 has already been closed.

It is also possible that the protrusion 38 and its interaction with the ribs 39 can prevent cut-off remnants of the insulation sheath from entering the inner chamber 47 of the housing 46.

For the embodiment shown, the housing 46 is not divided centrally. In this case, the ribs 39 are provided exclusively or primarily on the housing base 12, while the housing cover 7 does not comprise any ribs. However, any other division of the housing 46 is also possible.

The base body 16 of the second scissors part 3 enters the inner chamber 47 via a scissors part opening 62 of the housing 46. The base body 16 then extends through the inner chamber 47 and the base body 16 and/or the associated separating cutting blade 10 then exit/exits the inner chamber 47 in the area of the bit of separating cutting blades 57 via a separating cutting blade opening 63.

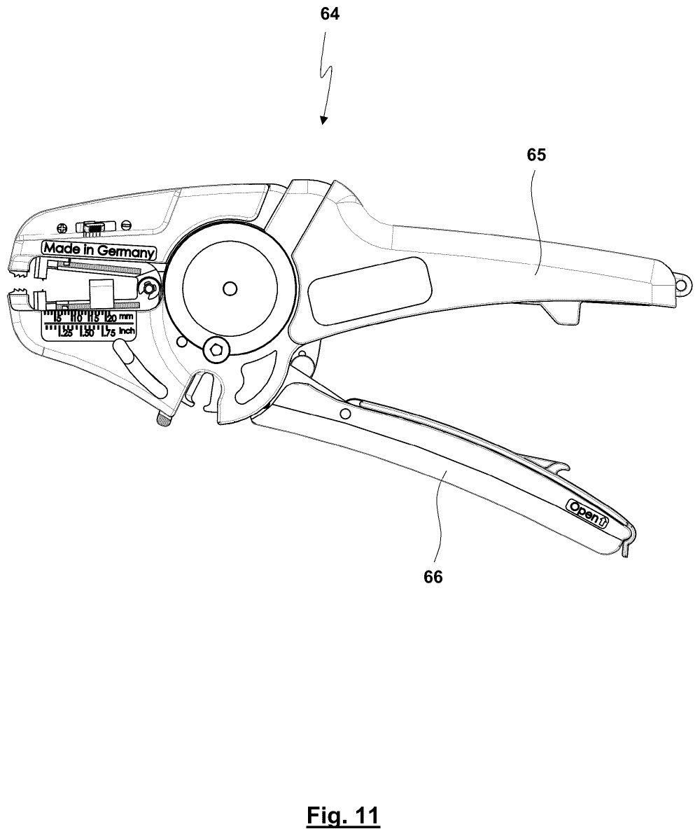

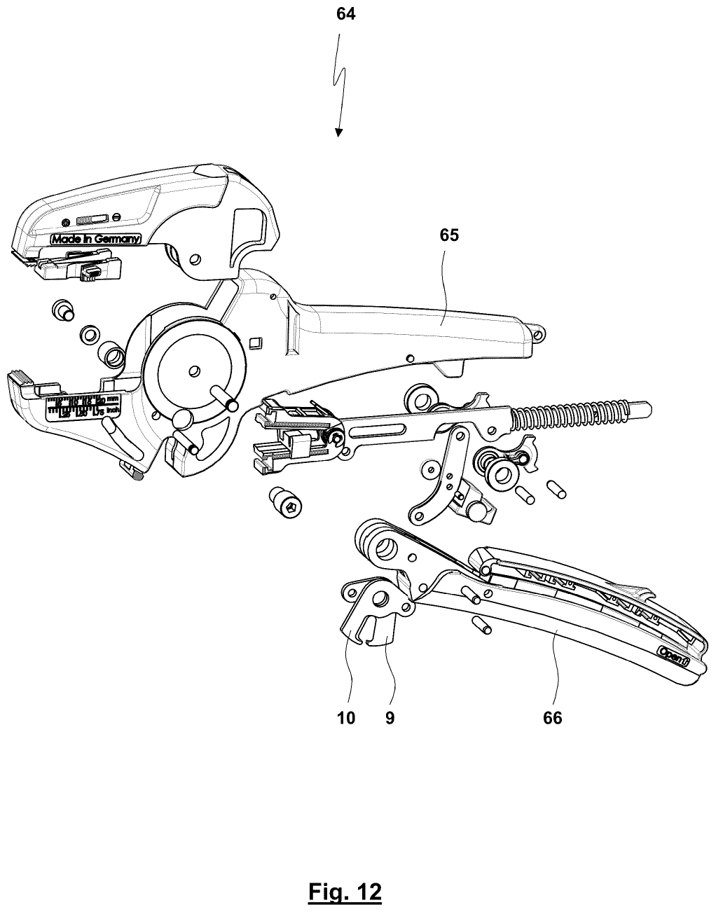

FIGS. 11 and 12 show a pliers tool 64. On the one hand, a cutting separating movement of separating cutting blades 9, 10 of the pliers tool 64 can be brought about via pliers hand levers 65, 66. In addition, the stroke of the pliers hand levers 65, 66 can also be used to press stripping incision blades against an insulation sheath for incising in an incision stroke part and to pull off the incised end section in a subsequent stripping stroke part by moving a carriage on which the stripping incision blades are held. With regard to further design features and functions of the pliers tool 64, reference is made to publication EP 3 054 542 B1, the relevant content of which being included into the present disclosure. Preferably, identical pairs of separating cutting blades 9, 10 are used for the scissors tool 1 on the one hand and the pliers tool 64 on the other hand, wherein (as already explained above) identical separating cutting blades can be used in the pairs of separating cutting blades 9, 10.

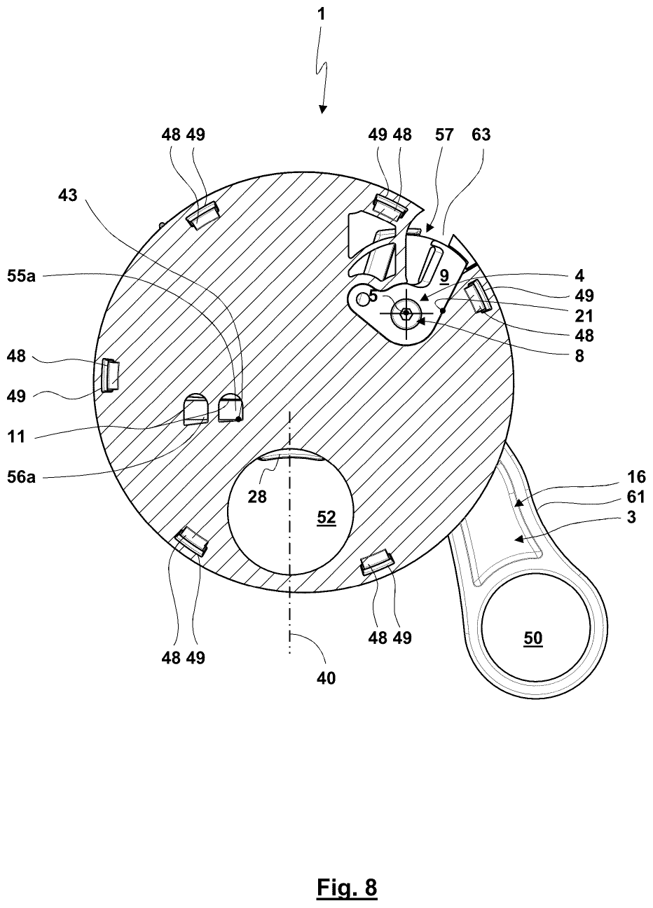

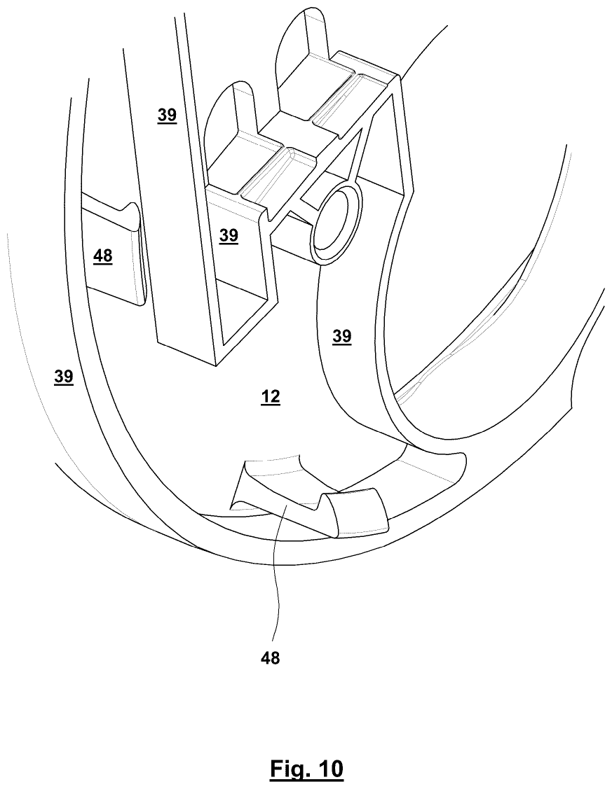

It is possible that with the scissors tool 1 according to FIGS. 1 to 10, the incised or cut-off end section of the insulation sheath is stripped by the stripping incision blade 11 immediately after the insulation sheath has been incised. However, it is also possible that the incised or cut-off end section of the insulation sheath remains in its original position on the conductor or is only partially removed (and possibly torn off). In this way, the end piece can protect the conductor, e.g. against splicing of the strands of a cable. The end section can then be removed later if a connection is to be made between a connection part and the end of the conductor that has been freed from the end section.

In the present application, “cutting” preferably means the complete cutting or severing of the cable and so of both the conductor and the insulation sheath for separating two parts of the cable, in particular for cutting the cable to length. Instead, “Incising” preferably means cutting only the insulation sheath along a part of the circumference or along the whole circumference (in the ideal case without cutting into the conductor).

Many variations and modifications may be made to the preferred embodiments of the invention without departing substantially from the spirit and principles of the invention. All such modifications and variations are intended to be included herein within the scope of the present invention, as defined by the following claims.

I claim:

1. A scissors tool for incising and cutting a cable comprising
a) a first scissors part and a second scissors part, which
are mounted on each other via a scissors joint so that they can pivot about a scissors pivot axis,
each comprise a finger accommodation by means of which it is possible to induce a pivoting movement of the scissors parts in a closing direction, and
each comprise a separating cutting blade, the separating cutting blades being moved towards each other with a pivoting movement of the scissors parts in the closing direction for cutting a cable between the separating cutting blades,
a stripping incision blade, the stripping incision blade being movably guided on the first scissors part between an insertion position and an incision position,
b) an actuating element which is integrated into the finger accommodation of the first scissors part and
c) a drive connection connecting the actuating element to the stripping incision blade.

2. The scissors tool of claim 1, wherein the drive connection is a rigid connection.

3. The scissors tool of claim 1, wherein the stripping incision blade is biased by a spring device towards the incision position and the stripping incision blade can be moved from the incising position into the insertion position by an actuation of the actuating element against a bias by the spring device.

4. The scissors tool of claim 3, wherein the spring device is pretensioned in the incision position.

5. The scissors tool of claim 1, wherein the actuating element projects into the finger accommodation of the first scissors part.

6. The scissors tool of claim 5, wherein maximum displacements of the actuating element and of the stripping incision blade are limited by to a movement of the actuating element into the insertion position, in which the actuating element and a limitation of the finger accommodation of the first scissors part are arranged flush with one another.

7. The scissors tool of claim 1, wherein the actuating element, a stripping incision blade holder and a spring device are manufactured in one single piece and the spring device is formed by a flexible material portion.

8. The scissors tool of claim 7, wherein the actuating element, the stripping incision blade holder and the spring device are made of plastic.

9. The scissors tool of claim 1, wherein the first scissors part comprises a housing with an inner chamber, in which at least one component of the scissors tool is arranged and/or supported.

10. The scissors tool of claim 9, wherein the housing comprises two housing parts.

11. The scissors tool of claim 10, wherein the housing comprises a housing cover and a housing base body.

12. The scissors tool of claim 9, wherein the second scissors part extends
a) through a scissors part opening of the housing of the first scissors part into the inner chamber of the housing and
b) through the inner chamber of the housing to a separating cutting blade opening of the housing.

13. The scissors tool of claim 1, wherein the first scissors part or the second scissors part comprises an accommodation in which the associated separating cutting blade is arranged and supported.

14. The scissors tool of claim 1, wherein a screw is provided, which defines at least one of
a) a friction which counteracts a pivoting of the scissors parts around the scissors joint
b) a cutting clearance of the separating cutting blades or
c) the scissors pivot axis.

15. The scissors tool of claim 1, wherein components of the scissors tool are joined in the same assembly direction, the assembly direction having an orientation parallel or coaxially to the scissors pivot axis.

16. The scissors tool of claim 1, wherein a cutting edge of the stripping incision blade is arranged at an acute angle with respect to a cable contact surface which supports a cable to be stripped on a side facing away from the stripping incision blade.

17. The scissors tool of claim 1, wherein components of the scissors tool are made of plastic.

18. The scissors tool of claim 17, wherein the plastic is a biogenic plastic.

19. A tool group comprising
a) at least one scissors tool for incising and cutting a cable comprising
a first scissors part and a second scissors part, which are mounted on each other via a scissors joint so that they can pivot about a scissors pivot axis, each comprise a finger accommodation by means of which it is possible to induce a pivoting movement the scissors parts in a closing direction, and each comprise a separating cutting blade, which are moved towards each other with a pivoting movement of the scissors parts in the closing direction for cutting a cable between the separating cutting blades,
a stripping incision blade, the stripping incision blade being movably guided on the first scissors part between an insertion position and an incision position,
an actuating element which is integrated into the finger accommodation of the first scissors part and
a drive connection connecting the actuating element to the stripping incision blade and
b) at least one pliers tool,
c) wherein the scissors tool and the pliers tool comprise identical separating cutting blades,
d) the separating cutting blades of the scissors tool are actuated by pivoting the scissors parts and
e) the separating cutting blades of the pliers tool are actuated by pivoting the pliers hand levers.
